(19) United States
(12) Patent Application Publication
(10) Pub. No.: US 2014/0340199 A1
(43) Pub. Date: Nov. 20, 2014

(54) REMOTE CONTROL DEVICE AND ELECTRONIC EQUIPMENT SYSTEM

(71) Applicant: Funai Electric Co., Ltd., Osaka (JP)

(72) Inventor: Yasuhiko KAWAI, Daito-shi (JP)

(73) Assignee: Funai Electric Co., Ltd., Osaka (JP)

(21) Appl. No.: 14/276,008

(22) Filed: May 13, 2014

(30) Foreign Application Priority Data
May 16, 2013 (JP) 2013-103689

(51) Int. Cl. G08C 17/02

(52) U.S. Cl. CPC G08C 17/02
USPC 340/12.5

(57) ABSTRACT

A remote control device outputs a wireless signal to operate electronic equipment and includes an operating unit operated by a user, a wireless signal output unit including a first signal output unit and a second signal output unit and configured to output the wireless signal in accordance with the operation, and a determination unit configured to determine whether or not a specified determination condition pertaining to a degree of difficulty for the wireless signal to reach and be received by the electronic equipment is satisfied, and when the determination condition is satisfied, the remote control device transitions from a first operating mode in which the first signal output unit is caused to output the wireless signal and the second signal output unit is caused not to output the wireless signal to a second operating mode in which the first signal output unit and the second signal output unit are caused to output the wireless signal.

### BACKGROUND OF THE INVENTION

1. Field of the Invention

The present invention relates to a remote control device and an electronic equipment system having this [remote control device].

2. Description of the Related Art

Remote control devices that are used to remotely operate electronic equipment have been widely utilized in the past. Remote control devices are configured so as to output wireless signals according to operations, and remote operations are realized as a result of these wireless signals arriving at electronic equipment.

However, it is difficult for wireless signals to reach electronic equipment if, for example, the electronic equipment and remote control device are too widely separated, or there is some kind of physical obstruction or noise factor between the two. When wireless signals have difficulty reaching electronic equipment, remote control does not work as well, and convenience is significantly reduced.

It may seem that boosting the strength of the output of the wireless signal to make it easier for the wireless signal to arrive is a good way to reduce the decline in remote control effectiveness as much as possible. However, boosting the strength of wireless signal output increases power consumption and tends to reduce the amount of battery life remaining, for example. Because of these situations, it is desirable to boost the strength of the wireless signal output depending on the degree of difficulty of the wireless signal reaching the electronic equipment rather than boosting the strength of the wireless signal output at all times.

### SUMMARY OF THE INVENTION

In light of the problems, preferred embodiments of the present invention provide a remote control device that boosts the strength of wireless signals output in accordance with a degree of difficulty for the wireless signal to be received by the electronic equipment, and an electronic equipment system including such a remote control device.

A remote control device according to a preferred embodiment of the present invention is a remote control device configured output a wireless signal to operate electronic equipment, wherein the remote control device includes an operating unit operated by a user; a wireless signal output unit including a first signal output unit and a second signal output unit and configured to output the wireless signal in accordance with the operation; and a determination unit which determines whether or not a specified determination condition pertaining to a degree of difficulty for the wireless signal to be received by the electronic equipment is satisfied, and it is configured such that when the determination condition is satisfied, the remote control device transitions from a first operating mode in which the first signal output unit is caused to output the wireless signal and the second signal output unit is caused not to output the wireless signal to a second operating mode in which the first signal output unit and the second signal output unit are caused to output the wireless signal.

By using this configuration, it is possible to boost the strength of the wireless signal output in accordance with a degree of difficulty for the wireless signal to be received at the electronic equipment. Note that the phrase “a specified determination condition pertaining to a degree of difficulty for the wireless signal to be received by the electronic equipment” refers to a condition that is fulfilled when the difficulty of this wireless signal arriving at the electronic equipment is relatively high, regardless of the specific nature thereof.

Furthermore, the determination condition may preferably be a condition pertaining to an operation in the operating unit. When a wireless signal has difficulty in reaching the electronic equipment, there is a tendency, for example, of a remote control operation to become less effective, causing the user to perform a characteristic operation. Because of this, the use of this configuration makes it possible to ascertain the degree of difficulty of the wireless signal arriving at and being received by the electronic equipment.

Moreover, the operating unit preferably includes a first operating key that is operated by being pressed down, and the determination condition is a condition that is fulfilled when the same first operating key is depressed at least a predetermined plural number of times within a specified length of time.

In addition, the operating unit preferably includes a second operating key that is operated by being pressed down, and the determination condition is a condition that is fulfilled when the same second operating key is depressed with more force than it was previously.

Furthermore, a return operation preferably is executed to return to the first operating mode after a predetermined period of time elapses from the transition to the second operating mode. As a result, it is possible to significantly reduce or prevent waste of power caused by the second operating mode continuing indefinitely, for example.

Moreover, a number of transitions from the first operating mode to the second operating mode preferably is counted, and the return operation is not executed when the number of transitions counted reaches a predetermined number of times. This makes it possible to prevent the return operation from being executed when a situation that makes it difficult for a wireless signal to arrive at and be received by the electronic equipment persists for a long period of time, for example.

In addition, a PWM control unit preferably is provided and performs PWM control on the output of the wireless signal, and the PWM control unit increases the duty ratio of the PWM control in the second operating mode beyond the duty ratio of the PWM control in the first operating mode. Furthermore, the first signal output unit and the second signal output unit preferably are light sources that emit the light of the wireless signal.

Moreover, the wireless signal output unit preferably is configured such that the optical axis of the first signal output unit and the optical axis of the second signal output unit are parallel or substantially parallel. Alternatively, the wireless signal output unit preferably is set such that the optical axis of the first signal output unit and the optical axis of the second signal output unit intersect.

Furthermore, in a remote control device of the configuration which is driven with the use of electric power supplied from a battery, the determination condition preferably is a condition that is fulfilled when the voltage of the battery is at or below a specified value.

Moreover, a remote control device according to another preferred embodiment of the present invention is a remote control device which outputs a wireless signal to operate electronic equipment, wherein the remote control device includes an operating unit operated by the user; a wireless signal output unit which outputs the wireless signal in accordance with the operation; a PWM control unit which performs PWM control on the output of the wireless signal; and a determination unit which determines whether or not a specified determination condition pertaining to a degree of difficulty for the wireless signal to be received by the electronic equipment is satisfied, and it is configured such that the PWM control unit increases the duty ratio of the PWM control when the determination condition is satisfied. This configuration makes it possible to boost the strength of the wireless signal output in accordance with the degree of difficulty for the wireless signal to be received by the electronic equipment.

In addition, the electronic equipment system according to a preferred embodiment of the present invention is configured so as to have the remote control device according to one of the preferred embodiments of the present invention described above and electronic equipment that is remotely operated by the remote control device. This configuration makes it possible to enjoy the benefits of a remote control device having such a configuration.

With the remote control device according to a preferred embodiment of the present invention, it is possible to boost the strength of the wireless signal output in accordance with a degree of difficulty for the wireless signal to be received by the electronic equipment. Furthermore, with the electronic equipment system according to a preferred embodiment of the present invention, it possible to enjoy the benefits of the remote control device according to one of the preferred embodiments of the present invention.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram of the electronic equipment system according to a first preferred embodiment of the present invention.

FIG. 2 is an external appearance diagram of the remote control device according to the first preferred embodiment of the present invention.

FIG. 3 is a flowchart pertaining to the operating mode switch processing according to the first preferred embodiment of the present invention.

FIGS. 4A-4C includes explanatory diagrams pertaining to the orientation of the optical axis of each light source.

FIG. 5 is a flowchart pertaining to the operating mode switch processing according to a second preferred embodiment of the present invention.

FIG. 6 is a block diagram of the electronic equipment system according to a third preferred embodiment of the present invention.

FIG. 7 is an external appearance diagram of the remote control device according to the third preferred embodiment of the present invention.

FIG. 8 is a graph pertaining to a configuration of the remote control signal when PWM control is performed.

FIG. 9 includes explanatory diagrams pertaining to the duty ratios of PWM control.

FIG. 10 is a block diagram of the electronic equipment system according to a fourth preferred embodiment of the present invention.

### DETAILED DESCRIPTION OF THE PREFERRED EMBODIMENTS

Preferred embodiments of the present invention will be described below with reference to drawings while citing each of first through fourth preferred embodiments as non-limiting examples. Note that in the following description, remote control operations will be referred to as remote control.

### First Preferred Embodiment

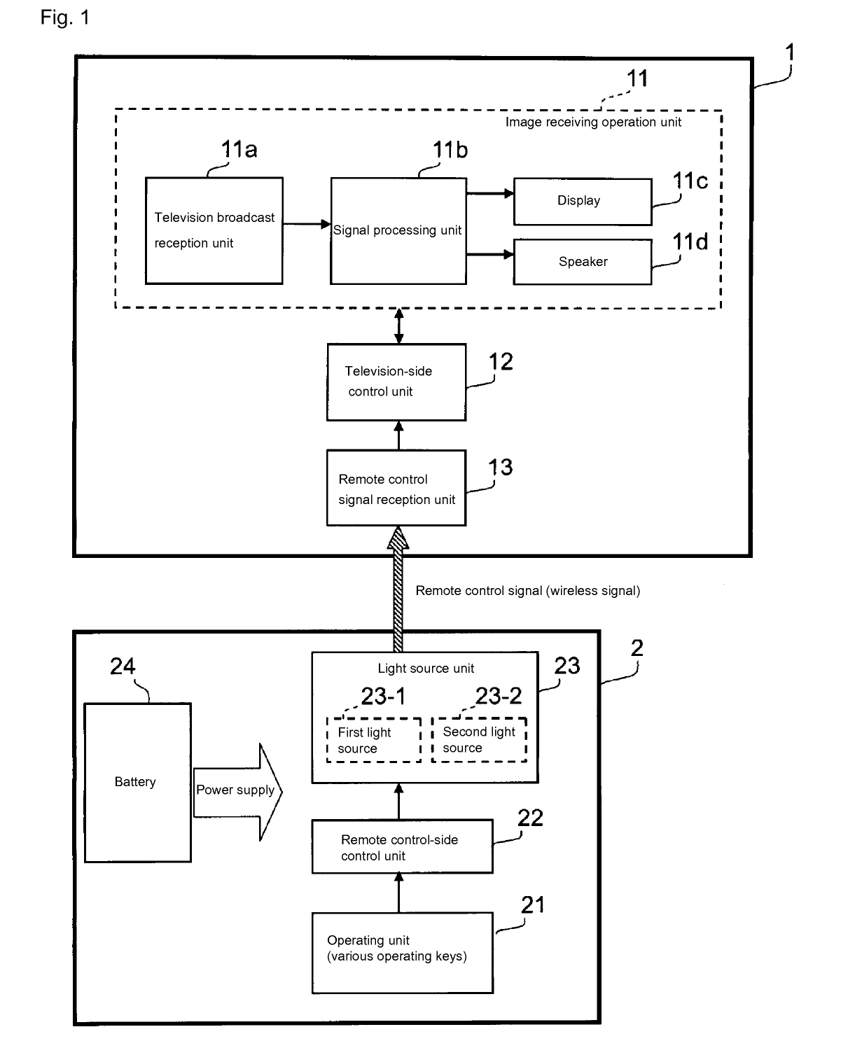

First, a first preferred embodiment of the present invention will be described. FIG. 1 is a block diagram pertaining to the configuration of the electronic equipment system according to the present preferred embodiment. This electronic equipment system, as shown in this figure, preferably includes a television broadcast receiver 1 and a remote control device 2, for example.

The television broadcast receiver 1 includes an image receiving operation unit 11, a television-side control unit 12, and a remote control signal reception unit 13. Furthermore, the image receiving operation unit 11 includes a television broadcast reception unit 11a, a signal processing unit 11b, a display 11c, a speaker 11d, and the like.

The television broadcast reception unit 11a is connected to an antenna, for example, and receives broadcast signals of television broadcasts as input. These broadcast signals contain the information on images and audio of television programs. Moreover, the television broadcast reception unit 11a includes a tuner, performs channel selection processing on broadcast signals, and sends signals of the selected channel (reception channel) to later stages.

The signal processing unit 11b performs specified processing (processing to demodulate or decode, processing to adjust images and sounds, etc.) on the broadcast signal received from the television broadcast reception unit 11a. The signal processing unit 11b thus generates image signals that include the image information of the television program and audio signals that include the audio information of the television program. The generated image signal is sent to the display 11c, and the audio signal is sent to the speaker 11d.

The display 11c preferably is a liquid crystal display, for example, and is configured to display images based on image signals received from the signal processing unit 11b. The speaker 11d is configured to output audio based on audio signals received from the signal processing unit 11b.

The television-side control unit 12 is configured and programmed to control the various components of the image receiving operation unit 11 and the like such that the television broadcast receiver 1 operates appropriately. For example, the remote control signal reception unit 13 is equipped with a light-receiving unit that is exposed on the front side of the television broadcast receiver 1 and receives a remote control signal (wireless signal) sent from the remote control device 2. In addition, the remote control signal reception unit 13 analyzes the received remote control signal and thus acquires operating information (information on key operations in the remote control device 2, which includes codes and the like that correspond to operating keys) that is included in this remote control signal.

The operating information obtained in this manner is sent to the television-side control unit 12. When the television-side control unit 12 receives operating information from the remote control signal reception unit 13, it controls the individual components such that this operating information is reflected.

The remote control device 2 includes an operating unit 21, a remote control-side control unit 22, a light source unit 23, a battery 24, and the like as shown in FIG. 1. The remote control device 2 is a device that is used to remotely operate the television broadcast receiver 1.

The operating unit 21 includes a plurality of operating keys (pushbutton-type key switches) that are operated by being pressed down by the user. Every time any of these operating keys is operated, the information of this key operation is transmitted to the remote control-side control unit 22.

The remote control-side control unit 22 controls the light source unit 23 such that a remote control signal corresponding to the key operation in the operating unit 21 is output. Furthermore, the remote control-side control unit 22 also has the function of determining whether or not specified determination conditions pertaining to the difficulty of the remote control signal arriving at the television broadcast receiver 1 are satisfied. Specific details of these determination conditions will be elucidated by the description provided further below. The remote control-side control unit 22 is designed so as to control the light source unit 23 according to the results of this determination.

The light source unit 23 includes a first light source 23-1 and a second light source 23-2 that serve as light sources capable of outputting the light of the remote control signal. These light sources (23-1 and 23-2) are LEDs that output infrared light, for example. The first light source 23-1 is basically always in use when outputting remote control signals. The second light source 23-2 is used together with the first light source 23-1 when in high-output mode, which will be described later. The battery 24 supplies drive power to the various components (including the remote control-side control unit 22 and light source unit 23) of the remote control device 2.

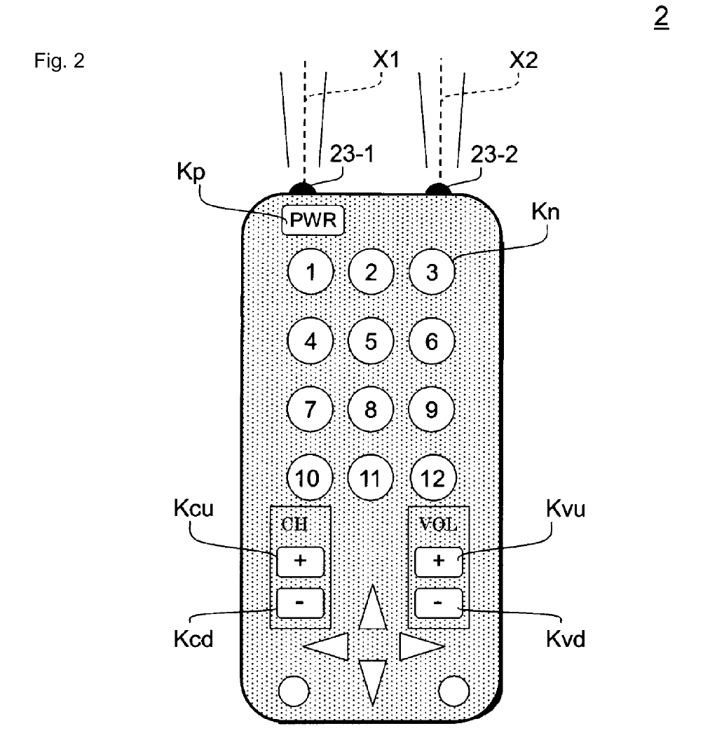

Moreover, FIG. 2 represents an external appearance diagram of the remote control device 2. As seen in this in FIG. 2, the remote control device 2 preferably includes a plurality of operating keys exposed on the surface of a casing that preferably is a rectangular or substantially rectangular parallelepiped, for example. Note that the operating key types include a power supply switch key Kp, individual number keys Kn (for 0 through 12), a channel-up key Kcu, a channel-down key Kcd, a volume-up key Kvu, and a volume-down key Kvd.

The power supply switch key Kp is an operating key that is pressed when the user wants to switch the power supply on the side of the television broadcast receiver 1 on or off. The number keys Kn are operating keys that are pressed when the user wants to specify the reception channel on the side of the television broadcast receiver 1 or the like directly (for example, when switching the reception channel to the channel of this entered number).

In addition, the channel-up key Kcu is an operating key that is pressed when the user wants to switch the reception channel on the side of the television broadcast receiver 1 in ascending order. Likewise, the channel-down key Kcd is an operating key that is pressed when the user wants to switch the reception channel on the side of the television broadcast receiver 1 in descending order.

Furthermore, the volume-up key Kvu is an operating key that is pressed when the user wants to increase the volume on the side of the television broadcast receiver 1 (the speaker 11d) one level at a time. Likewise, the volume-down key Kvd is an operating key that is pressed when the user wants to decrease the volume on the side of the television broadcast receiver 1 (the speaker 11d) one level at a time.

Moreover, as shown in FIG. 2, the first light source 23-1 and the second light source 23-2 are configured to be lined up on the same side surface of the casing of the remote control device 2. In addition, the optical axis X1 of the first light source 23-1 and the optical axis X2 of the second light source 23-2 are set up giving due consideration to facilitating the functioning of the remote control or the like. Note that the orientations of these optical axes (X1 and X2) will be described again in detail.

When the remote control signal that corresponds to pressing the power supply switch key Kp arrives at the remote control signal reception unit 13, the power supply of the television broadcast receiver 1 is switched on or off by the television-side control unit 12. Note that the television broadcasting receiver 1 executes normal operations including reception of television broadcasting when the power supply is on, but when the power supply is off, it does not perform television broadcasting reception or the like and is placed in a power saving state.

Furthermore, when the remote control signal that corresponds to pressing a number key Kn arrives at the remote control signal reception unit 13, the reception channel of the television broadcast receiver 1 is switched to the channel of this number key Kn by the television-side control unit 12. In the case of the remote control signal that corresponds to pressing the number key Kn for “3,” for example, the reception channel is switched to channel “3.”

Moreover, when the remote control signal that corresponds to pressing the channel-up key Kcu arrives at the remote control signal reception unit 13, the reception channel of the television broadcast receiver 1 is switched to the next channel in ascending order by the television-side control unit 12. Likewise, when the remote control signal that corresponds to pressing the channel-down key Kcd arrives at the remote control signal reception unit 13, the reception channel of the television broadcast receiver 1 is switched to the next channel in descending order by the television-side control unit 12.

In addition, when the remote control signal that corresponds to pressing the volume-up key Kvu arrives at the remote control signal reception unit 13, the volume of the television broadcast receiver 1 is increased by just one level by the television-side control unit 12. Likewise, when the remote control signal that corresponds to pressing the volume-down key Kvd arrives at the remote control signal reception unit 13, the volume of the television broadcast receiver 1 is decreased by just one level by the television-side control unit 12.

Note that the channel-up key Kcu, channel-down key Kcd, volume-up key Kvu, and volume-down key Kvd may also be designed such that when they are pressed in an extended manner (when the pressed state persists for at least a predetermined period of time), this is recognized as being equivalent to a plurality of consecutive presses.

Furthermore, the volume-up key Kvu and the volume-down key Kvd are operating keys to switch the volume one level at a time, so they may be operated a plurality of times consecutively within a short period of time (e.g., several seconds or so). For instance, in order to increase the volume three levels from the current level, the volume-up key Kvu is operated three times consecutively in this manner. Similarly, the channel-up key Kcu and the channel-down key Kcd are operating keys that switch the reception channel in an order, so they may be operated a plurality of times consecutively within a short period of time.

Operating keys that may be operated a plurality of times consecutively within a short period of time in the course of normal use in this manner are hereinafter referred to as operating keys of the “consecutive operation type.” Note that, in principle, the number keys Kn, for example, are not operated a plurality of times consecutively within a short period of time. Accordingly, the number keys Kn are not considered to be operating keys of the consecutive operation type.

As was described above, remote operation of the television broadcast receiver 1 is realized as a result of remote control signals that are sent from the remote control device 2 arriving at the television broadcast receiver 1. Moreover, the remote control device 2 performs processing to switch operating modes in parallel with operations that output remote control signals corresponding to key operations. Operating mode switch processing is a series of processes performed to appropriately switch the operating mode pertaining to outputting remote control signals in accordance with the difficulty of the remote control signal reaching the television broadcast receiver 1.

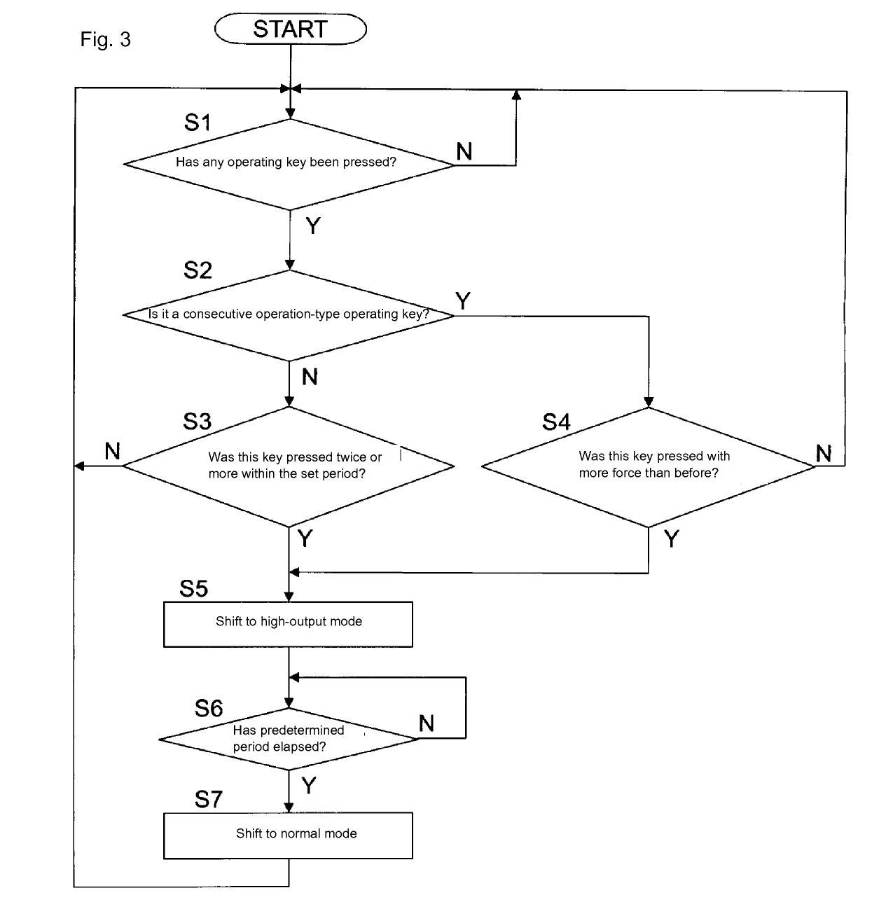

The details of the operating mode switch processing will be described below with reference to the flowchart shown in FIG. 3. Note that, normally, the operating mode of the remote control device 2 is a normal mode.

In the normal mode, the remote control-side control unit 22 controls the light source unit 23 such that the first light source 23-1 is caused to output a remote control signal while the second light source 23-2 is caused to not output a remote control signal. Doing so enables power consumption to be suppressed to the extent that the second light source 23-2 does not need to emit light, which can extend the life of the battery 24. In the normal mode, in order to suppress power consumption as much as possible, it is also possible to set the output strength of the first light source 23-1 such that the distance that the remote control signal extends is the minimum required (e.g., approximately 2 to 3 m).

In the normal mode, when any one of operating keys is pressed (Y in step S1), the remote control-side control unit 22 recognizes whether or not this pressed operating key is of the consecutive operation type (step S2).

If the pressed operating key is not of the consecutive operation type (N in step S2), the remote control-side control unit 22 determines whether or not this operating key was pressed twice or more including the current pressing within a set period of time (e.g., several seconds or so) (step S3). If this operating key was pressed twice or more within the set period, it is surmised that it is difficult for the remote control signal to reach and be received by the television broadcast receiver 1.

That is, it is hard to imagine that an operating key that is not of the consecutive operation type would be pressed twice or more within the set period of time for a normal operation. The fact that it was, nevertheless, pressed at least twice during the set period of time may thus have meant that the user pressed the key for the second and subsequent times in an attempt to get the remote control operation to work after the remote control signal did not reach the television broadcast receiver 1 the first time the key was pressed. Accordingly, in this case, the remote control signal is surmised to have had a difficult time reaching and being received by the television broadcast receiver 1.

In light of this, if this operating key is pressed twice or more within the set period of time (Y in step S3), then the operating mode of the remote control device 2 shifts to high-output mode (step S5). Note that the present preferred embodiment preferably uses “two” or more as the number of times that the key was pressed, but any number at least three may be used instead of “two”, for example. Alternatively, if this operating key is not pressed twice or more within the set period of time (N in step S3), then the flow of the operating mode switch processing returns to step S1.

In high-output mode, the remote control-side control unit 22 controls the light source unit 23 so as to have both the first light source 23-1 and the second light source 23-2 output the remote control signal. This makes it easier for the remote control signal to reach the television broadcast receiver 1 to the extent of the increase in the collective output strength of the remote control signal, thus making it easier for the remote control operation to work. Note that in high-output mode, the output strength of each of the light sources (23-1 and 23-2) may also be set such that the distance that the remote control signal travels is relatively long (e.g., approximately 8 m) in order to make it as easy as possible for the remote control signal to reach the television broadcast receiver 1.

Meanwhile, if the pressed operating key is of the consecutive operation type (Y in step S2), then the remote control-side control unit 22 determines whether or not the force of the pressing action on this operating key is higher now than it was previously (step S4). Note that the remote control device 2 is provided with pressure sensors that detect the force of the pressing action on each of the operating keys of the consecutive operation type, thus making it possible to perform such determination.

The fact that the current press is stronger than the previous press may thus mean that the user pressed the key harder this time, thinking that the last press was not strong enough because the remote control operation did not work after the remote control signal failed to reach and be received by the television broadcast receiver 1 the previous time the key was pressed. Accordingly, the remote control signal is surmised to have had a difficult time reaching the television broadcast receiver 1 in this case. For this reason, if this operating key is pressed harder currently than it was previously (Y in step S4) as well, the operating mode of the remote control device 2 shifts to high-output mode (step S5). Note that if this is not the case (N in step S4), the flow of the operating mode switch processing returns to step S1.

In addition, once a predetermined period has elapsed from the time of transition to high-output mode (Y in step S6), the operating mode of the remote control device 2 shifts to normal mode (step S7). Thereafter, the flow of the operating mode switch processing returns to step S1.

Note that, in the first preferred embodiment, an operation is performed which returns to normal mode when a predetermined period of time passes after the transition to high-output mode (a return operation), thus significantly reducing or preventing the waste of power which would be caused by high-output mode continuing indefinitely. However, when the difficulty in the remote control signal reaching and being received by the television broadcast receiver 1 persists for a long period of time, it may be convenient to have high-output mode continue even after the passage of the predetermined period of time, without performing the return operation. A preferred embodiment that takes this factor into account will be described later as a second preferred embodiment.

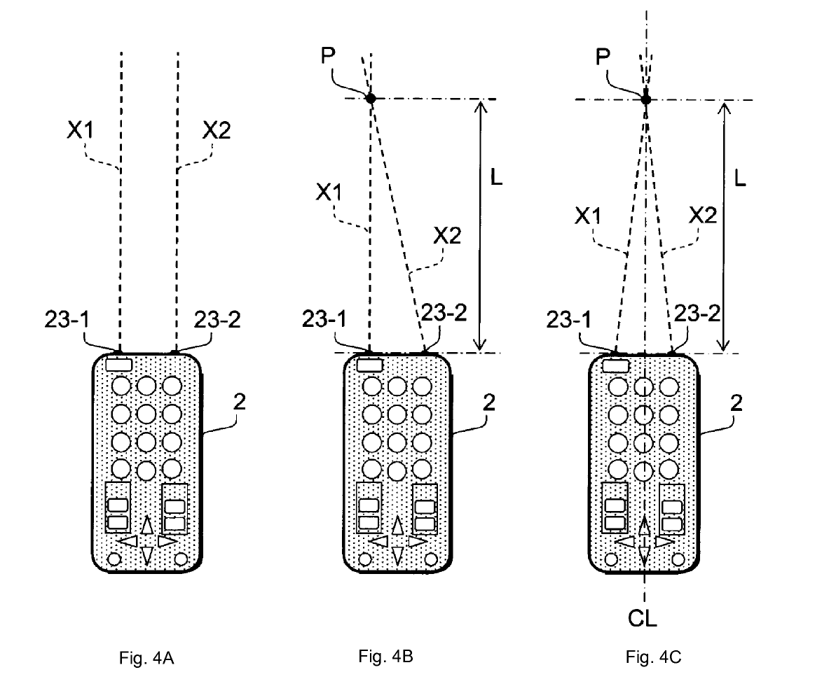

The orientations of the optical axis X1 of the first light source 23-1 and the optical axis X2 of the second light source 23-2 are configured, for example, as shown in FIGS. 4A through 4C by adjusting the mounting angle or the like of each of the light sources (23-1 and 23-2). These examples will be described in order below.

In the example of FIG. 4A, the light sources are preferably configured such that the optical axis X1 and the optical axis X2 are parallel or substantially parallel, for example. In this case, the range over which the remote control signal reaches as seen primarily from the top, bottom, left, and right (the orientations in which the normal plane of the optical axis extends) is relatively large. From this standpoint, the remote control operation works much easier and more effectively in the example of FIG. 4A.

In the example of FIG. 4B, the light sources are configured such that the optical axis X1 and the optical axis X2 intersect at a point P. Note that the orientation of the optical axis X1 is straight ahead (direction orthogonal to the side surface of the casing of the remote control device 2), and the orientation of the optical axis X2 is angled slightly from this straight-ahead orientation.

In the example of FIG. 4C, the light sources are set such that the optical axis X1 and the optical axis X2 intersect at a point P. Note that the orientation of the optical axis X1 and the orientation of the optical axis X2 are angled slightly from the straight-ahead orientation. Furthermore, the point P is located almost on the plane of symmetry CL of the remote control device 2.

In the cases of FIGS. 4B and 4C, the strength of the remote control signal is at its maximum at the point P. Moreover, the distance L from the remote control device 2 to the point P is set to the general distance between a user and the television broadcast receiver 1 (e.g., several meters or so). If the remote control device 2 is used such that the point P is close to the television broadcast receiver 1 (the remote control signal reception unit 13), the remote control signal is efficiently delivered to the television broadcast receiver 1. From this standpoint, the remote control operation works easier and more effectively in the examples of FIGS. 4B and 4C.

Note that the orientation of each of the optical axes (X1 and X2) is made adjustable by the user or the like, for example, by adopting a structure in which the mounting angle of each of the light sources (23-1 and 23-2) is freely altered. By doing so, the orientations of the individual optical axes (X1 and X2) are adjusted so as to be in any of the states shown in FIGS. 4A through 4C, for example.

As was described above, the remote control device 2 outputs remote control signals (wireless signals) to operate the television broadcast receiver 1. In addition, the remote control device 2 is equipped with the operating unit 21 that is operated by the user and the light source unit 23 (which includes the first light source 23-1 and second light source 23-2) that outputs a remote control signal in accordance with the user's operation. Furthermore, the remote control device 2 is equipped with the control unit 12 that determines whether or not determination conditions pertaining to how hard it is for remote control signals to arrive at the television broadcast receiver 1 (steps S3 and S4) are satisfied. Note that the first light source 23-1 and the second light source 23-2 configure one preferred embodiment of a signal output unit that outputs wireless signals. However, this signal output unit is not limited to the preferred embodiment in which the signal output unit includes light sources (the form in which optical wireless signals are output) but may also be a preferred embodiment in which non-optical wireless signals (electromagnetic waves or the like of lower frequency than light) are output.

Moreover, when either one of these determination conditions is satisfied, the remote control device 2 shifts from a normal mode, which causes the first light source 23-1 to output a remote control signal but causes the second light source 23-2 not to output a remote control signal, to a high-output mode, which causes the first light source 23-1 and the second light source 23-2 to output remote control signals. Therefore, the use of the remote control device 2 makes it possible to boost the strength of the remote control signal output according to the degree of difficulty for the remote control signal to reach and be received by the television broadcast receiver 1.

In addition, the determination conditions in the present preferred embodiment are conditions that relate to the user's operations on the operating unit 21. Note that the operating unit 21 includes first operating keys (operating keys that are not of the consecutive operation type, such as the number keys Kn) and second operating keys (consecutive operation-type operating keys) that are operated by being pressed.

Furthermore, the determination condition regarding the process of step S3 is a condition that is fulfilled when the same first operating key is depressed at least a predetermined plural number of times within a specified length of time. Moreover, the determination condition regarding the process of step S4 is a condition that is fulfilled when the same second operating key is pressed with force that is greater than the previous time it was pressed. In the remote control device 2 of the present preferred embodiment, the mode is shifted from normal mode to high-output mode when at least one of these determination conditions is satisfied.

Note that, in addition to the conditions, conditions that use the voltage of the battery 24, for example, may also be adopted as determination conditions regarding how difficult it is for the remote control signal to arrive at the television broadcast receiver 1. A preferred embodiment in which a condition that uses the voltage of the battery 24 is adopted as such a determination condition will be described later as a fourth preferred embodiment of the present invention.

### Second Preferred Embodiment

Next, a second preferred embodiment of the present invention will be described. Note that the second preferred embodiment preferably is basically the same as the first preferred embodiment, except for the points pertaining to the operating mode switch processing. In the following description, emphasis is placed on the description of the areas that are different from the first preferred embodiment, and the description of shared areas may be omitted.

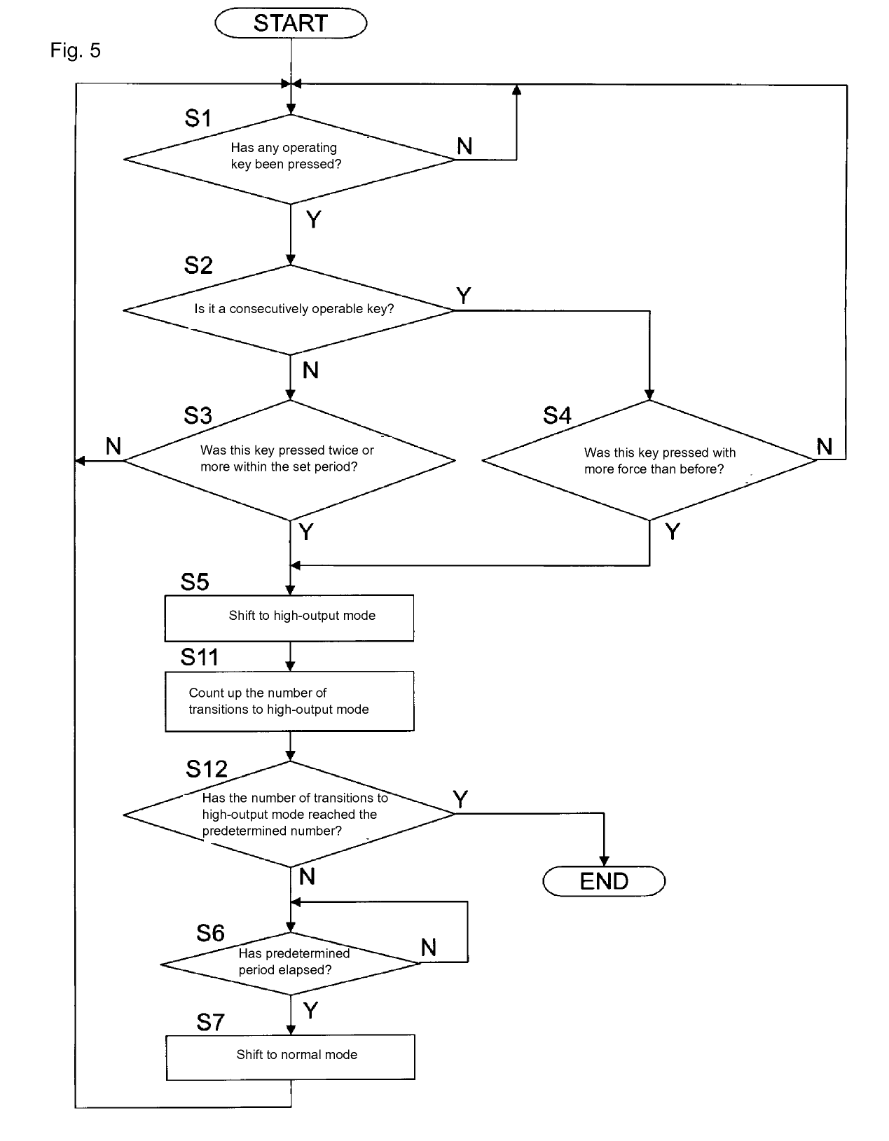

The details of the operating mode switch processing in the second preferred embodiment will be described below with reference to the flowchart shown in FIG. 5. Note that the operating mode switch processing in the second preferred embodiment is different from the case of the first preferred embodiment mainly in that processes in steps S11 and S12 are added.

When any one of the operating keys is pressed (Y in step S1) in the normal mode, the remote control-side control unit 22 recognizes whether or not this pressed operating key is of the consecutive operation type (step S2).

If the pressed operating key is not of the consecutive operation type (N in step S2), the remote control-side control unit 22 determines whether or not this operating key was pressed twice or more including the current pressing within a set period of time (step S3). If this operating key was pressed twice or more within the set period of time (Y in step S3), then the operating mode of the remote control device 2 shifts to high-output mode (step S5). Note that if this operating key was not pressed twice or more within the set period of time (N in step S3), the flow of the operating mode switch processing returns to step S1.

Meanwhile, if the pressed operating key is of the consecutive operation type (Y in step S2), the remote control-side control unit 22 determines whether or not the force of the pressing action on this operating key is higher now than it was previously (step S4). If this operating key is currently being pressed harder than it was previously (Y in step S4), then the operating mode of the remote control device 2 shifts to high-output mode (step S5). Note that if this is not the case (N in step S4), the flow of the operating mode switch processing returns to step S1.

When the mode is shifted to high-output mode, the remote control-side control unit 22 counts up the number of transitions to high-output mode (step S11). The number of transitions to high-output mode represents the number of times that normal mode has gone into high-output mode. Note that the number of transitions to high-output mode may be devised so as to be reset when the power supply switch key Kp is pressed, for example.

Next, the remote control-side control unit 22 determines whether or not the number of transitions to high-output mode has reached the predetermined number (e.g., three times) (step S12). If the predetermined number of times has not been reached (N in step S12), then once a predetermined period of time has elapsed from the time of transition to high-output mode (Y in step S6), the operating mode of the remote control device 2 shifts to normal mode (step S7). That is, a return operation is performed which returns to normal mode after a predetermined period of time has passed since the transition to high-output mode. Thereafter, the flow of the operating mode switch processing returns to step S1.

Meanwhile, if the predetermined number of times has been reached (Y in step S12), then the operating mode switch processing terminates with the operating mode of the remote control device 2 still remaining in high-output mode. Thus, the remote control device 2 is designed so as to count the number of transitions from normal mode to high-output mode and so as not to execute a return operation when this counted number of transitions reaches a predetermined number.

This means that high-output mode will continue thereafter even when the predetermined time elapses. Note that it is also possible to design the device such that after the operating mode switch processing has terminated, the operating mode of the remote control device 2 returns to normal mode, and the operating mode switch processing resumes when, for example, the power supply switch key Kp is pressed.

In the second preferred embodiment, when the state in which it is difficult for the remote control signal to reach and be received by the television broadcast receiver 1 persists for an extended period of time, it is expected that a shift to high-output mode will occur repeatedly and that the number of transitions to high-output mode will reach the predetermined value. For this reason, the second preferred embodiment is devised so as not to perform a return operation when the difficulty in the remote control signal reaching the television broadcast receiver 1 persists for a long period of time, thus allowing high-output mode to continue for an extended period of time, which, in turn, makes it as easy as possible for the remote control operation to work.

### Third Preferred Embodiment

Next, a third preferred embodiment of the present invention will be described. In the following description, emphasis is placed on the description of the areas that are different from the first preferred embodiment, and the description of shared areas may be omitted.

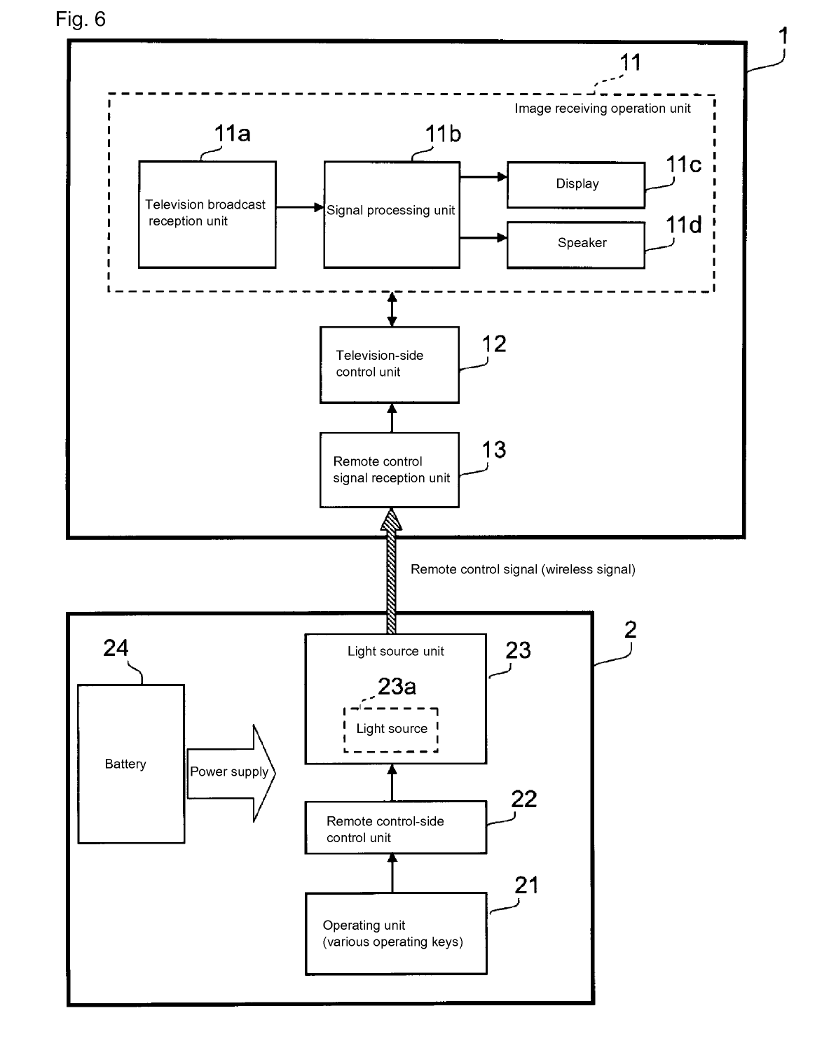

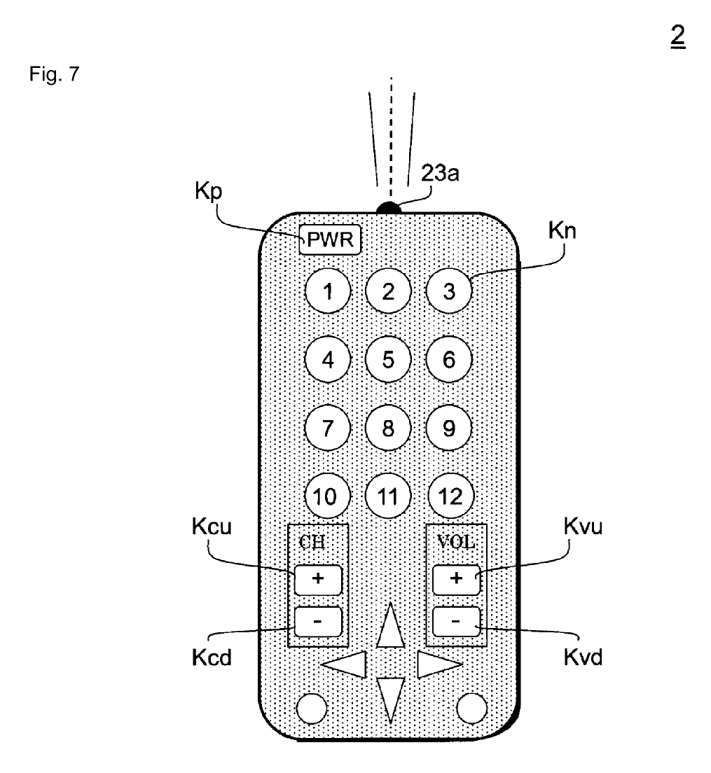

FIG. 6 is a block diagram pertaining to the configuration of the electronic equipment system according to the third preferred embodiment. In addition, FIG. 7 is an external appearance diagram of the remote control device 2 according to the third preferred embodiment. This electronic equipment system as shown in FIG. 6 includes a television broadcast receiver 1 and a remote control device 2 and is similar to the first preferred embodiment in this respect. However, the light source unit 23 of the remote control device 2 in the third preferred embodiment preferably includes a single light source 23a instead of including a first light source 23-1 and a second light source 23-2. The light source 23a is a light source configured to output the light of the remote control signal and is an LED that outputs infrared light, for example.

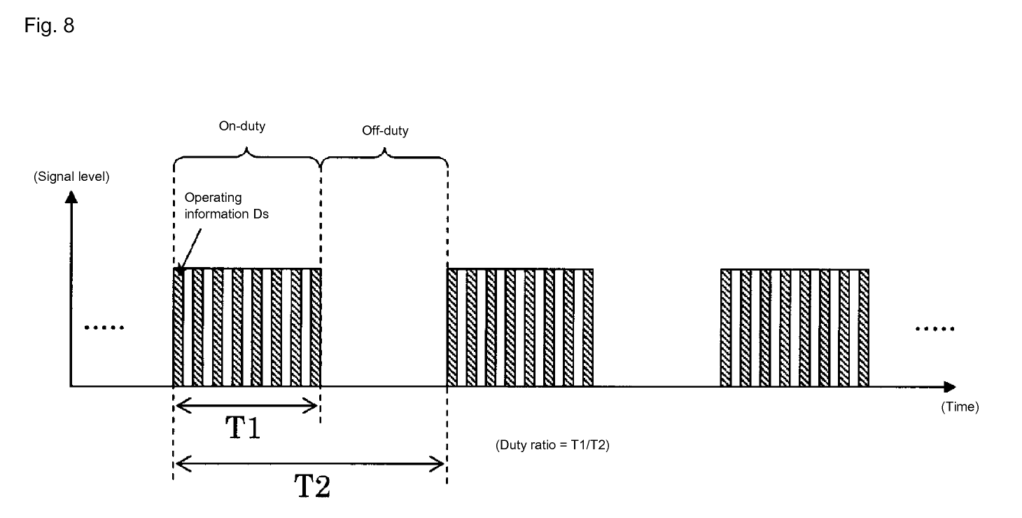

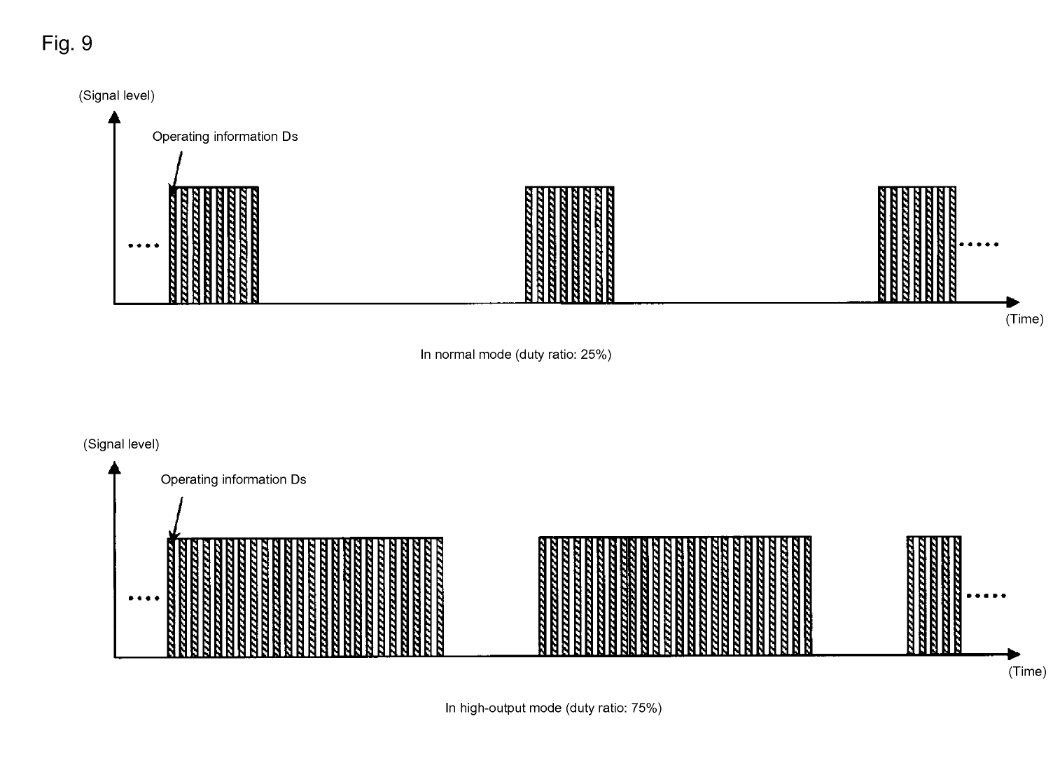

Furthermore, the remote control-side control unit 22 is designed so as to perform pulse width modulation (PWM) control (hereinafter referred to simply as “PWM control”) on the output of the light of the remote control signal. FIG. 8 is a graph showing in model form the form of the remote control signal when PWM control is performed. In FIG. 8 (and FIG. 9 as well), the horizontal axis indicates the time, while the vertical axis indicates the signal level. The remote control signal as shown in FIG. 8 alternates between an on-duty state that repeatedly indicates operating information Ds and an off-duty state in which the light source 23a never emits light. Note that the operating information Ds is information about key operations on the remote control device 2 (including codes or the like that correspond to operating keys).

Note that the ratio of the on-duty length T1 to the PWM control period T2, i.e., the duty ratio of PWM control (T1/T2), is preferably used to express the strength of the remote control signal output. The larger this duty ratio is, the easier it is for the remote control signal to reach and be received by the television broadcast receiver 1, and the easier it is for the remote control operation to work. However, power consumption increases to the extent that the light source 23a emits more light. Thus, it is advantageous to make the duty ratio smaller from the standpoint of significantly reducing or minimizing power consumption, but it is advantageous to make the duty ratio larger from the standpoint of making it easier for the remote control operation to work.

To this end, the remote control-side control unit 22 makes the duty ratio relatively small when the operating mode of the remote control device 2 is in the normal mode, and it makes the duty ratio relatively large when it is in the high-output mode. For example, the remote control-side control unit 22 is preferably configured and programmed to set the duty ratio to about 25% when in the normal mode and to set the duty ratio to about 75% when in high-output mode as shown in FIG. 9.

Thus, the remote control-side control unit 22 increases the duty ratio of PWM control when a determination condition similar to that in the first preferred embodiment (step S3 or S4) is satisfied. In the first preferred embodiment, the number of light sources used to output the remote control signal was changed according to the operating mode, whereas in the third preferred embodiment, the duty ratio of the PWM control is instead changed according to the operating mode. Thus, in the remote control device 2 of the second preferred embodiment as well, it is possible to boost the strength of the remote control signal output in accordance with the degree of difficulty for the remote control signal to reach and be received by the television broadcast receiver 1.

Note that the method for changing the duty ratio of the PWM control according to the operating mode can also be applied to the first preferred embodiment and second preferred embodiment. In such cases, the remote control-side control unit is preferably designed so as to change both the number of light sources used to output the remote control signal and the duty ratio of the PWM control according to the operating mode.

For example, in the normal mode, the remote control-side control unit 22 controls the light source unit 23 such that the first light source 23-1 outputs the remote control signal, while the second light source 23-2 does not output the remote control signal, and also such that the duty ratio of the PWM control becomes relatively small. When in the high-output mode, on the other hand, the remote control-side control unit 22 controls the light source unit 23 such that the first light source 23-1 and the second light source 23-2 output the remote control signal and also such that the duty ratio of the PWM control for at least one of these light sources becomes relatively large. Doing this enables the strength of the remote control signal output to be changed more effectively.

### Fourth Preferred Embodiment

Next, a fourth preferred embodiment of the present invention will be described. In the following description, emphasis is placed on the description of the areas that are different from the first preferred embodiment, and the description of shared areas may be omitted.

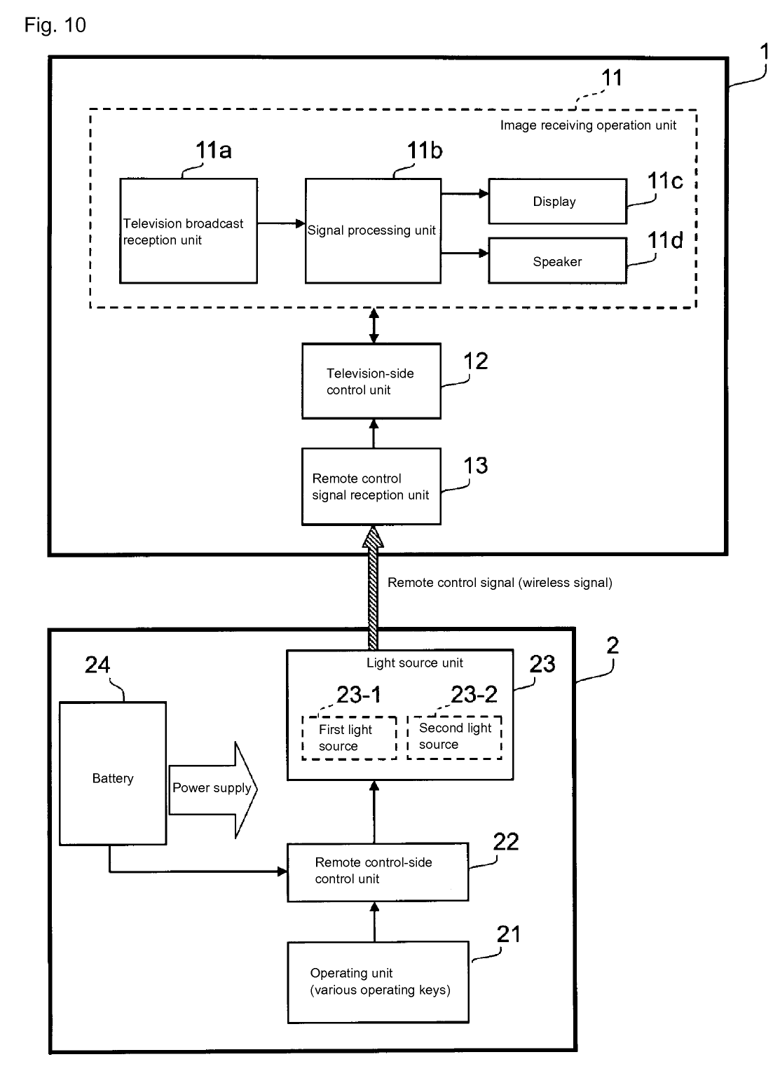

FIG. 10 is a block diagram pertaining to the configuration of the electronic equipment system according to the fourth preferred embodiment. This electronic equipment system as shown in FIG. 10 includes a television broadcast receiver 1 and a remote control device 2 and is similar to the first preferred embodiment in this respect. In the fourth preferred embodiment, the remote control-side control unit 22 is designed so as to also monitor the voltage of the battery 24.

Here, when the voltage of the battery 24 is too low, the strength of the light emitted by the light source decreases because the voltage supplied to the light source unit 23 decreases, and the strength of the remote control signal output falls to lower than usual. Therefore, the remote control signal is surmised to have had a difficult time reaching and being received by the television broadcast receiver 1 in this case. To this end, the remote control-side control unit 22 shifts the operating mode of the remote control device 2 to high-output mode when the voltage of the battery 24 drops to or below a specified value. This makes it possible to boost the output strength of the remote control signal in accordance with the difficulty of the remote control signal reaching or being received by the television broadcast receiver 1.

Note that the method for changing the operating mode of the remote control device 2 according to the voltage of the battery 24 can also be applied to the first through third preferred embodiments of the present invention, for example. In such cases, the remote control-side control unit 22 shifts the operating mode of the remote control device 2 to high-output mode not only when the condition of step S3 or S4 is satisfied, for example, but also when the voltage of the battery 24 drops to or below a specified value. By doing this, the operating mode of the remote control device 2 is more reliably shifted to the high-output mode when it becomes difficult for the remote control signal to reach the television broadcast receiver 1.

In the fourth preferred embodiment, as was described above, a condition that uses the voltage of the battery 24 was preferably adopted as a determination condition regarding how difficult it is for the remote control signal to arrive at the television broadcast receiver 1. In the remote control device 2 of the fourth preferred embodiment as well, it is possible to boost the strength of the remote control signal output in accordance with the difficulty of the remote control signal reaching the television broadcast receiver 1, just as in the case with the first preferred embodiment.

### Other Preferred Embodiments

Besides the various preferred embodiments and modified examples thereof, a variety of modifications can be made to the configurations of the present invention within its scope that does not depart from the gist of the present invention. The preferred embodiments configure illustrative examples in all respects and should be considered to be nonrestrictive. For instance, in the above description, a television broadcast receiver was cited as one example of the electronic equipment, but the electronic equipment that is operated by the use of the remote control device of the present invention is not limited to this.

Moreover, the technological scope of the present invention is indicated not by the description of the preferred embodiments but rather by the scope of the patent claims, and it should be understood to include all modifications with an equivalent meaning to and within the scope of the claims. In addition, various preferred embodiments of the present invention can be utilized in remote control devices that are used to operate various types of electronic equipment.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A remote control device which outputs a wireless signal to operate electronic equipment, the remote control device comprising:
an operating unit configured to be operated by a user;
a wireless signal output unit including a first signal output unit and a second signal output unit and configured to output the wireless signal in accordance with an operation selected by the user via the operating unit; and
a determination unit configured to determine whether or not a determination condition pertaining to a degree of difficulty of the wireless signal to reach or be received by the electronic equipment is satisfied; and
when the determination condition is satisfied, the remote control device is configured to transition from a first operating mode in which the first signal output unit is caused to output the wireless signal and the second signal output unit is caused not to output the wireless signal to a second operating mode in which the first signal output unit and the second signal output unit are caused to output the wireless signal.

2. The remote control device according to claim 1, wherein the determination condition is a condition pertaining to an operation of the operating unit.

3. The remote control device according to claim 2, wherein
the operating unit includes a first operating key that is operated by being pressed down; and
the determination condition is a condition that is fulfilled when a same first operating key is depressed at least a predetermined plural number of times within a specified length of time.

4. The remote control device according to claim 2, wherein
the operating unit includes a second operating key that is operated by being pressed down; and
the determination condition is a condition that is fulfilled when a same second operating key is depressed with more force than when previously depressed.

5. The remote control device according to claim 1, wherein a return operation is executed which returns to the first operating mode after a predetermined period of time elapses from a transition to the second operating mode.

6. The remote control device according to claim 5, wherein
a number of transitions from the first operating mode to the second operating mode is counted; and
the return operation is not executed when the number of transitions counted reaches a predetermined number of times.

7. The remote control device according to claim 1, wherein
a PWM control unit is provided and is configured to perform PWM control on an output of the wireless signal; and
the PWM control unit is configured to increase a duty ratio of the PWM control in the second operating mode beyond a duty ratio of the PWM control in the first operating mode.

8. The remote control device according to claim 1, wherein the first signal output unit and the second signal output unit are light sources that emit light of the wireless signal.

9. The remote control device according to claim 8, wherein the wireless signal output unit is configured such that an optical axis of the first signal output unit and the optical axis of the second signal output unit are parallel or substantially parallel.

10. The remote control device according to claim 8, wherein the wireless signal output unit is configured such that the optical axis of the first signal output unit and the optical axis of the second signal output unit intersect each other.

11. The remote control device according to claim 1, wherein
the remote control device is configured to be driven by electric power supplied from a battery; and
the determination condition is a condition that is fulfilled when a voltage of the battery is at or below a specified value.

12. A remote control device which outputs a wireless signal to operate electronic equipment, the remote control device comprising:
an operating unit configured to be operated by a user;
a wireless signal output unit configured to output the wireless signal in accordance with an operation selected by the user via the operating unit;
a PWM control unit configured to perform PWM control on an output of the wireless signal; and
a determination unit configured to determine whether or not a specified determination condition pertaining to a degree of difficulty of the wireless signal to reach or be received by the electronic equipment is satisfied; and
the PWM control unit is configured to increase a duty ratio of the PWM control when the determination condition is satisfied.

13. The remote control device according to claim 12, wherein the determination condition is a condition pertaining to an operation of the operating unit.

14. The remote control device according to claim 13, wherein
the operating unit includes a first operating key that is operated by being pressed down; and
the determination condition is a condition that is fulfilled when a same first operating key is depressed at least a predetermined plural number of times within a specified length of time.

15. The remote control device according to claim 13, wherein
the operating unit includes a second operating key that is operated by being pressed down; and
the determination condition is a condition that is fulfilled when a same second operating key is depressed with more force than when previously depressed.

16. The remote control device according to claim 12, wherein a return operation is executed which returns to the first operating mode after a predetermined period of time elapses from a transition to the second operating mode.

17. The remote control device according to claim 16, wherein
a number of transitions from the first operating mode to the second operating mode is counted; and
the return operation is not executed when the number of transitions counted reaches a predetermined number of times.

18. The remote control device according to claim 11, wherein
the first signal output unit and the second signal output unit are light sources that emit light of the wireless signal; and
the wireless signal output unit is configured such that an optical axis of the first signal output unit and the optical axis of the second signal output unit are parallel or substantially parallel, or the wireless signal output unit is configured such that the optical axis of the first signal output unit and the optical axis of the second signal output unit intersect each other.

19. An electronic equipment system comprising:
the remote control device according to claim 1; and
electronic equipment that is remotely operated by the remote control device.

20. An electronic equipment system comprising:
the remote control device according to claim 13; and
electronic equipment that is remotely operated by the remote control device.
